(19) United States
(12) Patent Application Publication
(10) Pub. No.: US 2008/0305677 A1
(43) Pub. Date: Dec. 11, 2008

(54) Electrical Connector for Flat Flexible Cable

(76) Inventor: Masahiro Koga, Kanagawa (JP)

Correspondence Address: HARRINGTON & SMITH, PC, 4 RESEARCH DRIVE, Suite 202, SHELTON, CT, 06484-6212, US

(21) Appl. No.: 11/666,564

(22) PCT Filed: Nov. 1, 2005
(86) PCT No.: PCT/JP05/20101

§ 371 Date: Aug. 11, 2008

(30) Foreign Application Priority Data
Nov. 1, 2004 (JP) 2004-317611

(51) Int. Cl. H01R 12/24

(52) U.S. Cl. 439/492

(57) ABSTRACT

An electric connector enabling multipolarization increasing the number of contact pieces by reducing a pressing force with which the contact pieces act on an actuator when the actuator is opened, including the actuator, the contact pieces, and a casing. The actuator includes an actuator body part and an actuator operation part. Each of the contact pieces comprises includes a top part beam, a contact beam, and a fixed base part beam. The contact beam and the top beam are formed in cantilever configurations. The contact beam opens the actuator so as to be pushed up when the actuator operation part touches near the free end of the contact beam to act a pressing force in one direction on the actuator operation part. The top part is pushed up when the actuator body part touches near the free end of the top beam to act a pressing force in the other direction facing the opposite direction of the pressing force to one direction of the contact beam on the actuator body part.

### TECHNICAL FIELD

The present invention relates to an electrical cable for connecting a flat flexible cable.

### BACKGROUND ART

Conventionally, the electrical connectors used for connecting flat flexible cables comprise a plurality of contact pieces arranged with a predetermined spacing inside an electrical connector, and an actuator for receiving and securing the flat flexible cable so that the contact pieces connect with contacts on the flat flexible cable.

The present applicant has previously proposed an electrical connector for grasping a flat flexible cable by the upper contacts.

This electrical connector comprises two types of contact pieces for grasping a flat flexible cable, a casing for housing the contact pieces and an opening/closing actuator, the contacts of the two types of contact pieces being spaced in the direction of insertion, and the contact pieces being alternately arrayed inside the casing to form a staggered row of contacts. The flat flexible cable can be inserted to the first type of contact piece without any insertion force, and to the second type of contact piece with a low insertion force (see Patent Document 1).
Patent Document 1: JP 2004-178931 A

### DISCLOSURE OF THE INVENTION

### Problems to be Solved by the Invention

However, with the above electrical connector, when the actuator is opened, the actuator and the contact beam of the contact piece but against each other, and the free end of the contact beam is pushed upward and deformed. At this time, the contact beam exerts a downward force (load) on the actuator, so the actuator deforms downward in the perpendicular direction (direction perpendicular to the direction of insertion of the flat flexible cable). Therefore, if the length of the actuator in the perpendicular direction is made longer, the deformation of the central portion thereof increases, thus restricting the number of contact pieces that may be included.

The present invention has the object of offering an electrical connector for a flat flexible cable that enables the number of contact pieces to be increased by reducing the force exerted by the contact pieces on the actuator when the actuator is opened to insert a flat flexible cable.

### Means for Solving the Problem

(1) In order to achieve the above purpose, the electrical connector for a flat flexible cable according to the present invention is an electrical connector for a flat flexible cable comprising an opening/closing actuator, a plurality of contact pieces contacting the flat flexible cable, and a casing holding the contact pieces; wherein the actuator comprises an actuator body portion, and a rotatable actuator action portion extending in a direction perpendicular to the direction of insertion of the flat flexible cable; the contact pieces are flat elements wherein a top beam, a contact beam having a contact contacting a first surface of the flat flexible cable, and a fixed base beam supporting a second surface of the flat flexible cable extend from a contact piece base portion; the contact beam and top beam are respectively formed as elements that extend in the form of a cantilever, the tip of which is free; the contact piece has a deforming ability wherein deformation occurs by being pushed upward when the actuator is opened and the actuator action portion buts against the vicinity of the free end of the contact beam, and due to this deforming ability, exerts a force in one direction on the actuator action portion; the top beam has a deforming ability wherein deformation occurs by being pushed downward when the actuator is opened and the actuator body portion buts against the vicinity of the free end of the top beam, and due to this deforming ability, exerts on the actuator action portion a force in another direction opposite the force in the one direction by said contact beam.
(2) Additionally, the actuator action portion preferably has a cross sectional shape in the insertion direction of the flat flexible cable such that the cross-sectional length in a long-axis direction is greater than a cross-sectional length in a short-axis direction, and the contact beam is pushed upward by rotation of the actuator action portion when the actuator is opened.
(3) The top beam preferably exerts said force on the actuator body portion in said other direction when the actuator is opened by butting against the actuator body portion, but is separated from the vicinity of the free end of the contact beam.
(4) The top beam preferably exerts said force on the actuator body portion in said other direction when the actuator is opened by butting against the actuator body portion, and also butting against the vicinity of the free end of the contact beam.
(5) The actuator preferably receives, from the plurality of contact pieces arranged at positions spaced in the direction perpendicular to the direction of insertion of the flat flexible cable, a force which is the difference between the force in the one direction from the contact beams and the force in the other direction from the top beams.

### EFFECTS OF THE INVENTION

(1) In the invention according to claim 1, when the actuator is opened to insert the flat flexible cable, the contact beam of the contact piece buts against the actuator action portion, so that the free end of the contact beam is pushed in the upward direction and deformed, and a force in one direction (downward direction) is exerted on the actuator action portion, but the top beam exerts a force on the actuator body portion in the other direction (upward direction) opposite to the force in the one direction (downward direction) by the contact beam, by butting against the actuator body portion.

Therefore, the force in the one direction by the contact beam and the force in the other direction by the top beam cancel each other out as loads in the opposite direction, so the actuator receives a force which is the difference between the force in the one direction from the contact beam and the force in the other direction from the top beam, thus enabling the amount of deformation of the central portion in the perpendicular direction (direction perpendicular to the direction of insertion of the flat flexible cable) of the actuator to be suppressed, and enabling a large number of contact pieces to be included to provide many terminals.

(2) In the invention according to claim 2, the actuator action portion has a cross-sectional shape formed so that the cross-sectional length in the long-axis direction is greater than the cross-sectional length in the short axis direction, so when the actuator is in an open state, the top edge in the long axis direction of the actuator action portion and the contact beam come into contact, thus allowing for deformation of the contact beam by being pushed upward.
(3) In the invention according to claim 3, the top beam buts against the actuator body portion when the actuator is opened, but it is separated from the vicinity of the free end of the contact beam, so that said force in the other direction is exerted on the actuator body portion, and the force of the contact beam in the one direction and the force of the top beam in the other direction cancel each other out as loads in the opposite direction via the actuator.

Furthermore, the top beam and contact beam extend in the form of a cantilever in opposition to each other from the contact piece base portion, so rotational deformation of the contact piece base portion which is a fixed end occurring due to deformation of the free end of the top beam in the one direction (downward direction) enables the deformation in the other direction (upward direction) of the free end of the contact beam to be made small.

(4) In the invention according to claim 4, the top beam buts against the actuator body portion when the actuator is opened, and also buts against the vicinity of the free end of the contact beam, so that increases in deformation in the up-down direction of the vicinity of the free end of the contact beam are directly restricted by means of the actuator body portion via the top beam.
(5) In the invention according to claim 5, the actuator receives a force which is the difference between the force in one direction from the contact beam and the force in the other direction from the top beam, from a plurality of contact pieces that are spaced apart in the direction perpendicular to the direction of insertion of the flat flexible cable, so the length of the actuator in the perpendicular direction can be made larger, enabling more contact pieces to be added to provide many terminals.

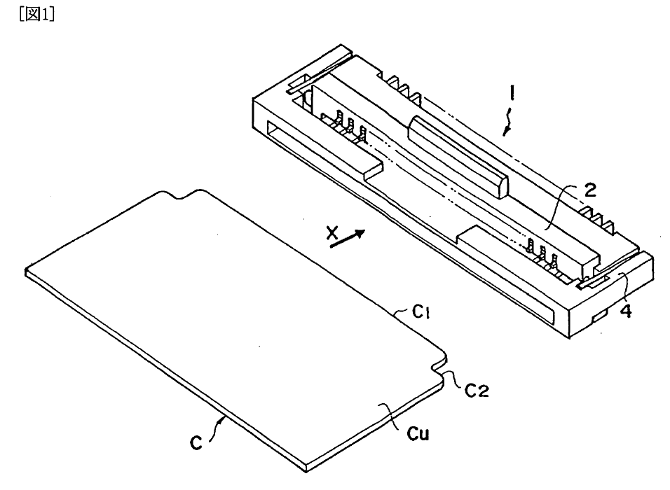

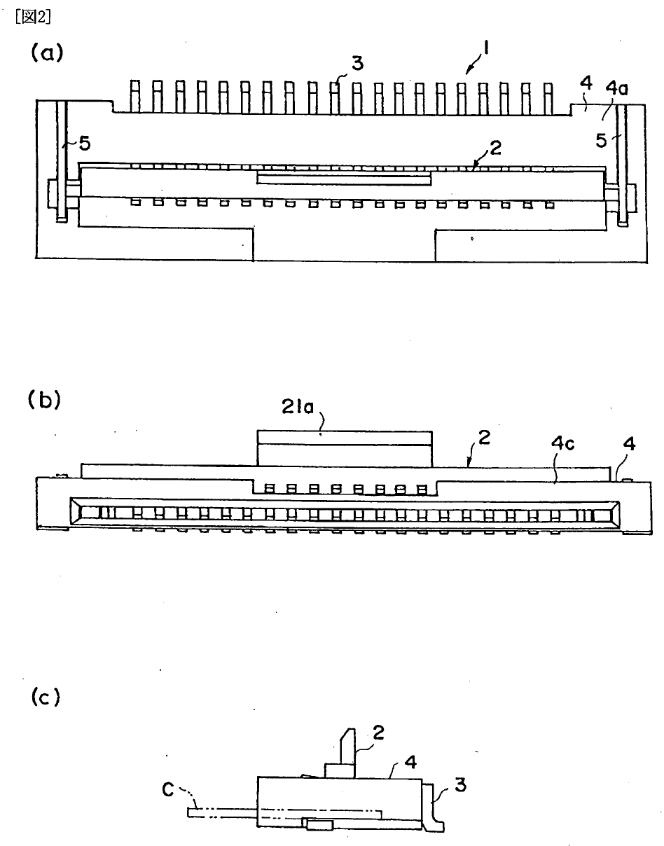

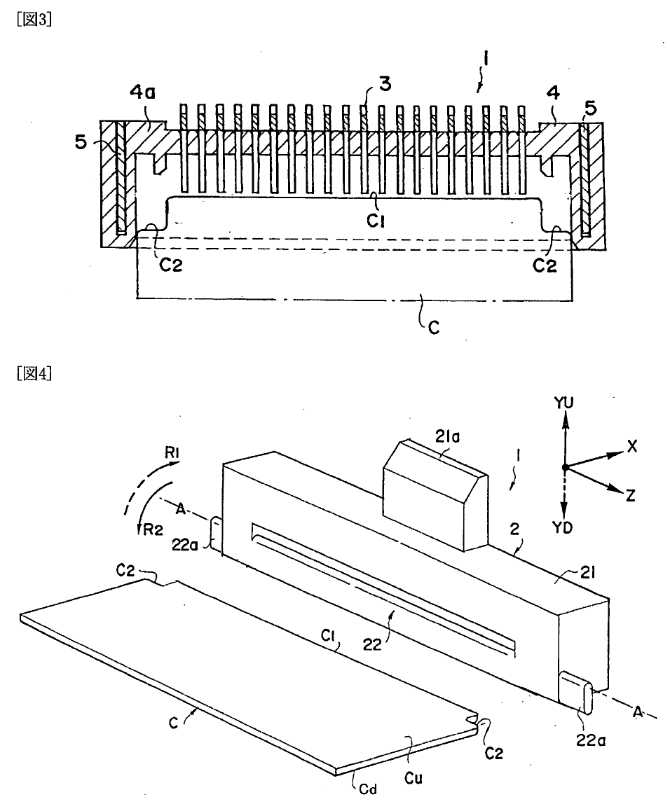

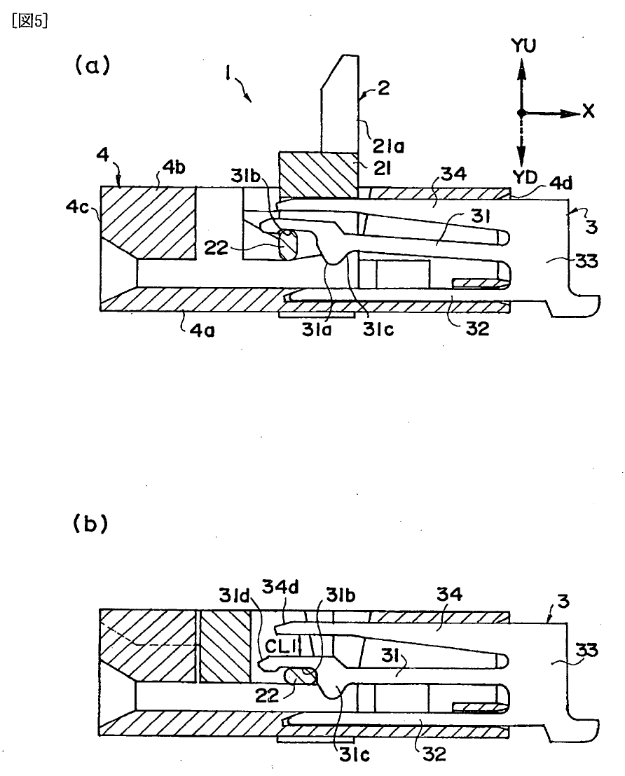

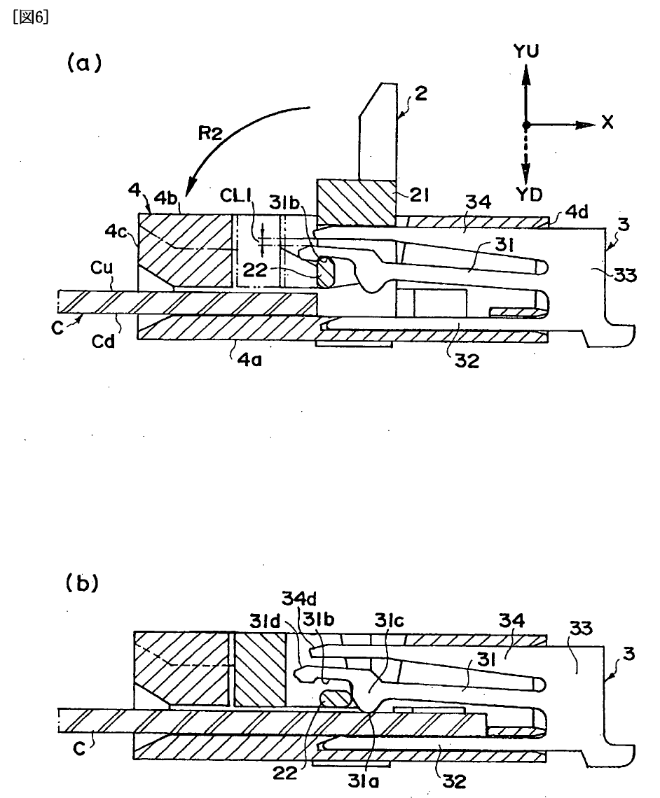

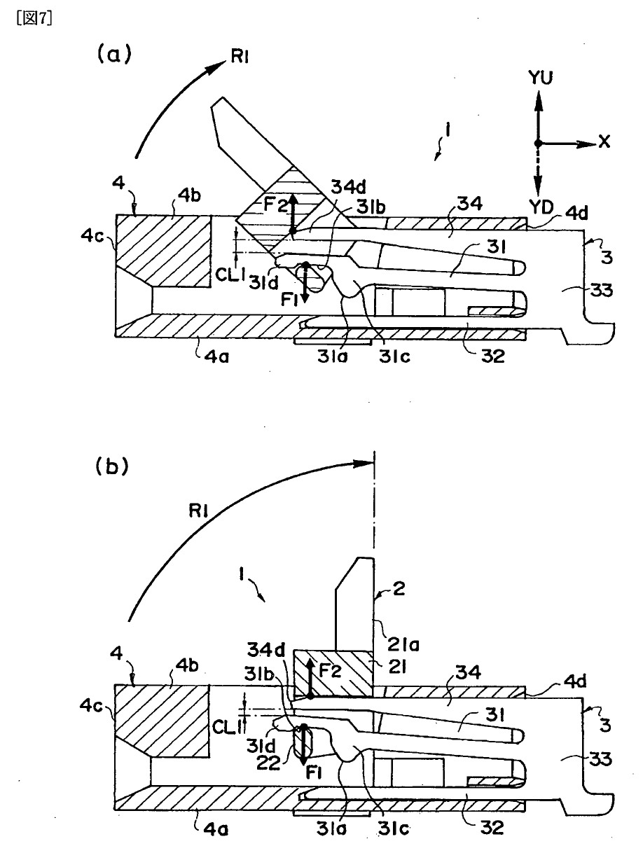

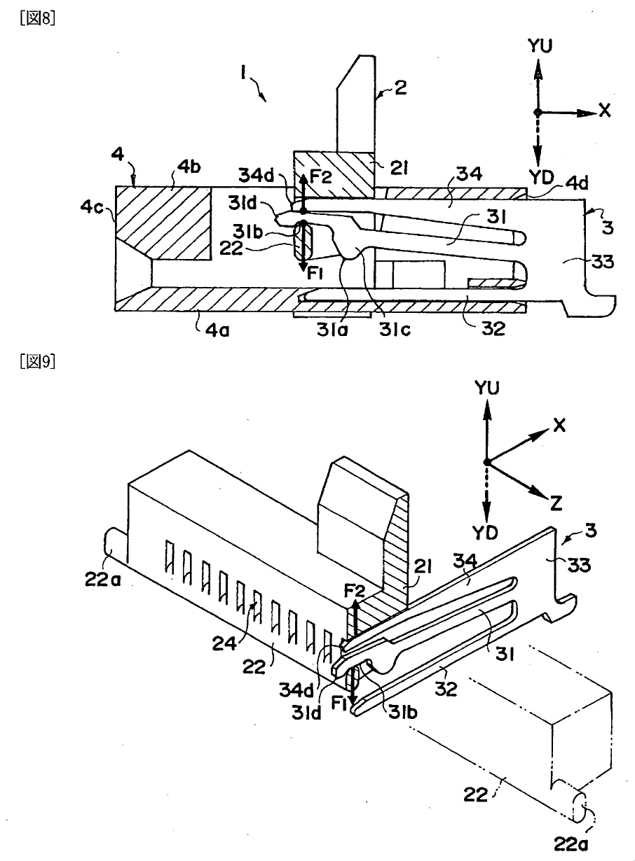

### BRIEF DESCRIPTION OF THE DRAWINGS

[FIG. 1] A perspective view of an electrical connector 1 according to Embodiment 1, seen with the actuator 2 in an open state.

[FIG. 2] A plan view (a), front view (b) and a side view (c) of the electrical connector 1 with the actuator 2 in an open state.

[FIG. 3] A plan view with a flat flexible cable C inserted.

[FIG. 4] A perspective view showing the relationship between the flat flexible cable C and the actuator 2 in the electrical connector 1 of FIG. 1.

[FIG. 5] (a) and (b) are side views of an electrical connector 1 with the actuator 2 in an open state and in a closed state (flat flexible cable C not inserted).

[FIG. 6] (a) and (b) are side views of an electrical connector 1 with the actuator 2 in an open state and in a closed state (flat flexible cable C not inserted).

[FIG. 7] (a) and (b) are side views of an electrical connector with the actuator 2 in an open state.

[FIG. 8] A side view of an electrical connector 1 with the actuator 2 in an open state.

[FIG. 9] A perspective view of an electrical connector 1 showing the relationship of upward/downward force between the contact piece 3 and the actuator 2 with the actuator in an open state.

### EXPLANATION OF REFERENCE NUMBERS

1 . . . electrical connector
2 . . . actuator
3 . . . contact piece
4 . . . casing
5 . . . reinforcing resilient portion
21 . . . actuator body portion
21a . . . actuator grip portion
22 . . . actuator action portion
22a . . . end portions of actuator action portion
31 . . . contact beam
31a . . . contact beam contact
31b . . . contact beam abutment portion
31c . . . contact beam projecting portion
31d . . . free end of contact beam
32 . . . fixed bottom beam
33 . . . contact piece base portion
34 . . . top beam
34d . . . free end of top beam
C . . . flat flexible cable
C1 . . . front face of flat flexible cable
C2 . . . cutaway portion of flat flexible portion

### BEST MODES FOR CARRYING OUT THE INVENTION

Examples of preferred embodiments of the present invention shall be described with reference to the drawings. In the drawings, the same reference numbers are used for the same elements, and their explanations may be omitted.

### Embodiment 1

FIG. 1 is a perspective view showing an electrical connector 1 with the actuator 2 in an open state. FIG. 2 shows a plan view, front view and side view of the electrical connector 1 with the actuator 2 in an open state. FIG. 3 is a plan view with a flat flexible cable C inserted.

First, the flat flexible cable C shall be explained. While such cables include many types such as flexible printed cable (FPC) and flexible flat cable (FFC), they shall be referred to collectively in the present specification as flat flexible cable C below.

The flat flexible cable C is in the form of a thin sheet of roughly rectangular shape in plan view, with cutaway portions C2 at both ends of the front surface portion C1 of the flat flexible cable C. The flat flexible cable C has a “top contact” structure wherein a plurality of contacts are arranged on a first surface (top surface) CU (contacts not shown in FIG. 1). When the flat flexible cable C is inserted into the electrical connector 1, the contacts of the flat flexible cable C come into contact with the contact pieces 3 to complete a connection.

The electrical connector 1 comprises an opening/closing actuator 2, a plurality of contact pieces 3 contacting the flat flexible cable C and a casing 4 holding the contact pieces 3.

The reference number 5 in FIGS. 2 and 3 indicates a reinforcing fitting 5, which is a flat metal element provided at the end portions 22a, 22a of the actuator 2 and affixed to the bottom plate 4a of the casing 4.

FIG. 4 is a perspective view focusing on only the actuator 2 and flat flexible cable C in the electrical connector 1 shown in FIG. 1, omitting the contact pieces 3 and the casing 4.

In the electrical connector 1 shown in FIG. 4, X denotes the direction of insertion of the flat flexible cable C, Z denotes the direction perpendicular to the direction of insertion of the flat flexible cable C (hereinafter referred to as “perpendicular direction Z”), YU denotes the upward direction and YD denotes the downward direction. Here, X and Z lie on a single plane in the direction of insertion of the flat flexible cable C. YU and YD lie on a plane in an extraplanar direction perpendicular to the plane of the direction of insertion, YU being the direction toward the upper plane 4b of the casing 4 and YD being the direction toward the bottom plate 4a of the casing 4. The upward direction YU and downward direction YD are terms used for convenience of explanation, and are not meant to refer strictly to the up-down direction at the position of installation of the electrical connector 1. R1 denotes a rotation direction (clockwise in FIG. 4) in which the actuator 2 opens, and R2 denotes a rotation direction (counterclockwise in FIG. 4) in which the actuator 2 closes.

As shown in FIG. 4, the actuator 2 comprises an actuator body portion 21 and an actuator action portion 22 that is rotatable about the perpendicular axis Z.

The actuator body portion 21 is a lid that can be opened or closed with respect to the top plate 4b of the casing 4, having at its tip an actuator grip portion 21a for gripping with the hand.

Since the actuator body portion 21 and the actuator action portion 22 are formed with an integrated structure, the actuator body portion 21 and the actuator action portion 22 rotate about the perpendicular direction Z as a single body.

The actuator action portion 22 is a rod-shaped body that supports the actuator body portion 21 so as to be rotatable about the perpendicular axis Z. The actuator action portion 22 has a straight line in the perpendicular direction Z passing through an arbitrary point in the cross section of the element as an axis of rotation A (indicated by the single-dotted dashed line in FIG. 4). The end portions 22a, 22a protrude by a certain length from the end surfaces of the actuator body portion 21, these end portions 22a, 22a being elements for restricting the rotation of the actuator 2, and supported in a floating state. For example, the end portions 22a, 22a of the actuator action portion 22 can be supported in a floating state by adding reinforcing fittings formed as separate elements.

The central portion of the actuator action portion 22 is separated from the actuator body portion 21 by slits into which the contact pieces 3 are inserted depending on the number (20 in Embodiment 1) of contact pieces 3, the slits being arrayed along an axis A of rotation. However, in FIG. 4, twenty slits are simply shown as a single elongated slit for explanation of the figure.

The actuator action portion 22 has a cross section roughly in the shape of an ellipse whose cross-sectional length in the long-axis direction is greater than the cross-sectional length in the short-axis direction. Here, the cross-sectional shape of the actuator action portion 22 refers to the cross-sectional shape in the plane perpendicular to the axis of rotation A (perpendicular direction Z).

The cross-sectional shape of the actuator action portion 22 can be made into a shape other than roughly elliptical, as long as the cross-sectional length in the long-axis direction is greater than the cross-sectional length in the short axis direction. The difference between the cross-sectional length in the long-axis direction and the cross-sectional length in the short-axis direction of the actuator action portion 22 is adjusted so as to form a clearance in the up-down direction between the fixed bottom beam 32 and the contact beam projecting portion 31c such that the flat flexible cable C can be inserted with zero insertion force (see FIGS. 5 and 6).

FIG. 5 shows side views of the electrical connector 1 with the actuator 2 in an open state and a closed state without the flat flexible cable C inserted. FIG. 6 shows side views of the electrical connector 1 with the actuator 2 in an open state and a closed state with the flat flexible cable C inserted.

As shown in FIGS. 5 and 6, each contact piece 3 is a flat element comprising a top beam 34, a contact beam 31 having a contact 31a for contacting a first surface (top surface) CU of the flat flexible cable C, and a fixed bottom beam 32 supporting a second surface (bottom surface) Cd of the flat flexible cable C, extending from a contact piece base portion 33 in opposition to each other.

While a plurality (20 in Embodiment 1) of contact pieces 3 are arrayed at a predetermined spacing along the perpendicular direction Z of the casing 4, the contact pieces 3 are inserted from the rear surface portion 4d of the casing and affixed to the casing.

The top beam 34 is an element (see FIGS. 5 and 6) that extends in the form of a cantilever from the contact piece base portion 33, for which the tip portion (front surface 4c side of the casing) is free and the base portion (rear surface 4d side of the casing) is fixed.

The top beam 34 is an element that is positioned so as to suppress deformation of the contact beam 31 in the upward direction YU in the vicinity of the free end 31d when the actuator 2 is open.

The top beam 34 has the ability to deform by being pushed downward when the actuator 2 is opened and the actuator body portion 21 buts against the top beam 34 in the vicinity of the free end 34d, and due to this deforming ability, enables a force F2 in the upward direction YU (other direction), opposite the force F1 in the downward direction YD (one direction) on the contact beam 31, to be exerted on the actuator body portion 21.

A clearance CL1 is formed in the up-down direction (see FIG. 5) between the top side of the free end 31d of the contact beam 31 and the bottom side of the free end 34d of the top beam 34, so that while the free end 31d of the contact beam 31 and the free end of the top beam 34 are spaced apart when the actuator is closed, the free ends will not come into contact when the actuator 2 is opened.

While the top side of the free end 34d of the top beam 34 does not abut the actuator body portion 21 when the actuator 2 is closed, they come into abutment when the actuator 2 is opened (see FIGS. 5(a) and 6(a)).

The length of overhang of the free end 34d of the top beam 34 from the contact piece base portion 33 in the direction of insertion X of the flat flexible cable C is roughly the same length as the length of overhang of the free end 31d of the contact beam 31 from the contact piece base portion 33.

The contact beam 31 is an element (see FIGS. 5 and 6) that extends in the form of a cantilever from the contact piece base portion 33, for which the tip portion (front surface 4c side of the casing) is free and the base portion (rear surface 4d side of the casing) is fixed.

The contact beam 31 forms a contact beam abutment portion 31b that buts against the actuator action portion 22 on the bottom side near the free end 31d, and has a contact beam projecting portion 31c that projects downward at a position midway between the free end and the base portion, the lowermost portion of the contact beam projecting portion 31c forming a contact 31a connecting to the first surface CU of the flat flexible cable C.

Since the contact beam 31 is formed into an element that extends in cantilever form with the tip being free, when the actuator 2 is opened and the actuator action portion 22 is rotated, the contact beam 31 has the ability to deform (elastic deformation) by being pushed upward when the actuator action portion 22 buts against the contact beam abutment portion 31b, and this deforming ability also enables a force to be exerted on the actuator action portion 22 in the downward direction YD (one direction).

By adjusting the difference between the cross-sectional length in the long axis direction and the cross-sectional length in the short axis direction of the actuator action portion 22, the value of the pressure on the contact beam 31 in the downward direction YD can be adjusted.

Since the actuator action portion 22 is formed with a cross section roughly in the shape of an ellipse whose cross-sectional length in the long axis direction is longer than the cross-sectional length in the short-axis direction, when the actuator 2 is in an open state, the upper edge in the long axis direction of the actuator action portion 22 and the contact beam abutment portion 31b of the contact beam 31 but against each other, with the free end 31d of the contact beam 31 being pushed upward and deformed (elastic deformation) (see FIGS. 5(a) and 6(a)).

On the other hand, when the actuator 2 is closed without the flat flexible cable C inserted, the upper edge portion in the short-axis direction of the actuator action portion 22 and the contact beam abutment portion 31b of the contact beam 31 come into contact, but the free end 31d of the contact beam 31 is not pushed upward, and is therefore not deformed (elastic deformation) (see FIG. 5(b)).

In the state wherein the actuator 2 is closed after insertion of a flat flexible cable C, the upper edge portion in the short axis direction of the actuator action portion 22 and the contact beam abutment portion 31b of the contact beam 31 are separated, so the upward-directed pressure between the contact beam 31 and the actuator action portion 22 is relieved, but the contact 31a of the contact beam projecting portion 31c is in contact with the first surface CU of the flat flexible cable C, so the contact beam 31 presses on the flat flexible cable C in a downward direction YD (see FIG. 6(b)).

The fixed base beam 32 is an element that extends straight from the contact piece base portion 33, the bottom side of which is affixed to the bottom plate 4a of the casing.

Since the return force of the contact beam 31 exerts a force in the downward direction YD, the contact 31a of the contact beam 31 connects with the first surface CU of the flat flexible cable C, and the top side of the fixed base beam 32 connects with the second surface (bottom surface) Cd of the flat flexible cable C, so that the flat flexible cable C is pinched from above and below by the contact beam 31 and the fixed base beam 32 for connection to the contact piece 3 (see FIG. 6(b)).

Next, the mechanism for the up-down forces between the contact piece 3 and actuator 2 when the actuator 2 is opened shall be explained with reference to FIGS. 5, 7 and 8.

As a first step, the state where the actuator 2 is closed without the flat flexible cable C inserted as shown in FIG. 5(b) shall be explained. The actuator action portion 22 has a cross-sectional shape roughly forming an ellipse whose cross-sectional length in the long axis direction is longer than the cross-sectional shape in the short axis direction, so the upper edge in the short axis direction of the actuator action portion 22 buts against the contact beam abutment portion 31b of the contact beam 31. However, the cross-sectional length in the short-axis direction of the cross section of the actuator action portion 22 can be set so that the free end 31d of the contact beam 31 will not deform in the upward direction YU even if the upper edge portion in the short axis direction of the actuator action portion 22 and the contact beam abutment portion 31b are in contact. If the free end 31d of the contact beam 31 is not deformed in an upward direction YU, a force in the upward direction YU is not exerted from the actuator action portion 22 onto the contact beam 31. Furthermore, the top side of the free end 31d of the contact beam 31 is separated from the bottom side of the free end 34d of the top beam 34, so the free end 34d of the top beam 34 is likewise not deformed.

Next, the state in which the actuator 2 is being opened and the actuator action portion 22 is rotating in the direction of rotation R1 shall be explained as a second step shown in FIG. 7(a) (FIG. 7(a) shows the case where the angle of rotation is roughly 45 degrees).

In the second step, the top side of the free end 31d of the contact beam 31 and the bottom side of the free end 34d of the top beam 34 are separated by a clearance CL1.

When the long axis direction of the cross section of the actuator action portion 22 begins to come into contact with the contact beam abutment portion 31b of the contact beam 31, the actuator action portion 22 forcibly deforms the free end 31d of the contact beam 31 by pushing it in an upward direction YU. Since the contact beam 31 is formed of an element that extends in cantilever form with the tip being free and the base being fixed, the deforming ability of the contact beam 31 in the upward direction YU generates a return force in the downward direction YD to return to the original position. The contact beam 31 acts on the actuator action portion due to the return force in the downward direction YD, with the force F1 in the downward direction YD (one direction) as a load. Here, when the contact beam 31 is formed of a resilient element, the force F1 in the downward direction YD will be determined roughly based on the rigidity of the element as a cantilever receiving a concentrated load on the free end and the amount of deformation in the upward direction YU.

Here, since the top beam 34 is also formed as an element that extends in the form of a cantilever with its tip free and its base fixed, the top beam 34 will act to suppress deformation in the upward direction YU of area in the vicinity of the free end 31d of the contact beam 31.

The top side of the free end 34d of the contact beam 34 does not abut against the actuator body portion 21 when the actuator 2 is closed, but when the actuator 2 is opened, they enter a state of contact. When the top beam 34 and the actuator body portion 21 begin to come into contact, the actuator body portion 21 causes the free end 34d of the top beam 34 to be forcibly deformed by being pressed in the downward direction YD. The top beam 34 has a return force in the upward direction YU for returning to the original position by means of the deforming ability in the downward direction YD. The top beam 34 acts on the actuator body portion 21 with a force F2 in an upward direction YU (other direction) as the load due to this return force in the upward direction YU.

However, since the actuator is formed with the actuator body portion 21 and the actuator action portion 22 in an integrated form, the force F1 in the downward direction YD that the contact beam 31 exerts on the actuator action portion 22 and the force F2 in the upward direction YU that the top beam 34 exerts on the actuator body portion 21 cancel each other out as load in the opposite direction.

Next, the state in which the actuator 2 is opened and upright shall be explained as the third step shown in FIG. 7(b) (showing the case where the angle of rotation is roughly 90 degrees).

In the third step, the top side of the free end 31d of the contact beam 31 and the bottom side of the free end 34d of the top beam 34 are separated by a clearance CL1.

When the actuator 2 is opened, the top edge in the long-axis direction of the cross section of the actuator action portion 22 and the contact beam abutment portion 31b of the contact beam 31 are in a state of contact, and deformation in the upward direction YU of the free end 31d of the contact beam 31 increases.

However, the actuator body portion 21 becomes upright with the top side of the free end 34d of the contact beam 34 and the actuator body portion 21 in contact, so the actuator body portion 21 forcibly deforms the top beam 34 by pressing strongly in the downward direction YD on the free end 34d. As a result, the force F2 in the upward direction YU that the top beam exerts on the actuator body portion 21 becomes large, and the force F1 in the downward direction YD exerted by the contact beam 31 on the actuator action portion 22 and the force F2 in the upward direction YU exerted by the top beam 34 on the actuator body portion 21 cancel each other out as loads acting in the opposite direction on roughly the same line.

Furthermore, the top beam 34 and the contact beam 31 extend in the form of cantilevers in opposition to each other from the contact piece base portion 33, so rotational deformation of the contact piece base portion 33 which is a fixed end that occurs due to deformation of the free end 34d of the top beam 34 in one direction (downward direction) reduces the deformation of the free end 31d of the contact beam 31 in the other direction (upward direction).

Next, the top beam 34 contacts the actuator body portion 21 with the actuator 2 in an open and upright state in a fourth step shown in FIG. 8 (showing the case where the angle of rotation is roughly 90 degrees).

A clearance CL1 in the up-down direction can be formed between the top side of the free end 31d of the contact beam 31 and the bottom side of the free end 34d of the top beam 34 so that the free end 31d of the contact beam 31 and the free end of the top beam 34 are separated when the actuator is closed, but when the actuator 2 is opened, the free ends 31d, 34d come into contact.

When the top beam 34 comes into contact in the vicinity of its free end 34d with the contact beam 31 which is deformed when the actuator is open, and also comes into contact with the actuator body portion 21, the deformation in the upward direction YU, of the free end 34 of the top beam 34 and the free end 31d of the contact beam 31 will change to a mechanism that is restrained by the actuator body portion 21.

At this time, the top beam 34 acts on the actuator body portion 21 with a force F2 in the upward direction YU as the load. Since the actuator body portion 21 and the actuator action portion 22 form the actuator as an integrated structure, the force F1 in the downward direction YD exerted by the contact beam 31 on the actuator action portion 22 and the force F2 in the upward direction YU exerted by the top beam 34 on the actuator body portion 21 will act to cancel each other out as loads in opposite directions on roughly the same line.

Here, if the structure is such that the force F1 in the downward direction YD (one direction) and the force F2 in the upward direction YU (other direction) are made roughly the same, the forces in the opposite directions having roughly the same value along roughly the same line will balance (internal equilibrium) and remain stable.

The structure is not limited such that the force F1 and the force F2 must act on roughly the same line, and the load positions may be eccentric loads that are shifted in the direction of insertion X of the flat flexible cable.

Next, the deformation mechanism whereby the actuator 2 receives forces (loads) F1, F2 in upward and downward directions from the contact piece 3 (contact beam 31, top beam 34) will be explained with reference to FIG. 9.

The actuator 2 is formed with a structure such that the actuator body portion 21 and the actuator action portion 22 are integrated. A plurality (20 in Example 1) of contact pieces 3 are arrayed along the perpendicular direction Z of the actuator action portion 22 spaced apart by a predetermined distance. The actuator body portion 21 and actuator action portion 22, as an integrated structure, resist the loads F1, F2 from upward and downward directions received from the contact beam 31 and the top beam 34.

The actuator action portion 22 is supported on the casing 4 by the end portions 22a, 22a with a straight line in the perpendicular direction Z passing through an arbitrary point in the cross section of the element as the axis of rotation A. The structure of the actuator 2 in the perpendicular direction Z is that of a three-dimensional structure that is elongated in the perpendicular direction Z, supported in a floating state at the end portions 22a, 22a of the actuator action portion 22.

Herebelow, the states of the second step to the fourth step wherein the actuator 2 is deformed by forces (loads) F1, F2 in the upward and downward directions received from the contact beam 31 and the top beam 34 will be explained with reference to FIG. 9. FIG. 9 shows the state of the loads in the second step to the fourth step.

In each of the second step to the fourth step, the actuator 2 receives a force F3 in the downward direction which is the difference between the force F1 in the downward direction YD from the contact beam 31 and the force F2 in the upward direction YU from the top beam 34. The perpendicular direction Z of the actuator 2 receives the force F3 in the downward direction YD from a plurality of contact beams 31, and deforms to form a bow-shaped deformation curve which is convex in the downward direction.

However, since the force F3 in the downward direction YD is small in each of the second step to the fourth step, the amount of deformation in the downward direction YD of the central portion of the actuator 2 in the perpendicular direction Z will be small.

Therefore, the present invention enables the length of the actuator 2 in the perpendicular direction Z to be made long, thus enabling many terminals to be included by increasing the number of contact pieces.

While an embodiment of the present invention has been explained above by giving an example, the present invention is not limited to the above example, and can include additions or modifications within the range of the gist of the present invention.

1. An electrical connector for a flat flexible cable comprising an opening/closing actuator, a plurality of contact pieces contacting the flat flexible cable, and a casing holding the contact pieces; wherein
the actuator comprises an actuator body portion, and a rotatable actuator action portion extending in a direction perpendicular to the direction of insertion of the flat flexible cable;
the contact pieces are flat elements wherein a top beam, a contact beam having a contact contacting a first surface of the flat flexible cable, and a fixed base beam supporting a second surface of the flat flexible cable extend from a contact piece base portion;
the contact beam and top beam are respectively formed as elements that extend in the form of a cantilever, the tip of which is free;
the contact beam has a deforming ability wherein deformation occurs by being pushed upward when the actuator is opened and the actuator action portion buts against the vicinity of the free end of the contact beam, and due to this deforming ability, exerts a force in one direction on the actuator action portion;
the top beam has a deforming ability wherein deformation occurs by being pushed downward when the actuator is opened and the actuator body portion buts against the vicinity of the free end of the top beam, and due to this deforming ability, exerts on the actuator action portion a force in another direction opposite the force in the one direction by said contact beam.

2. An electrical connector for a flat flexible cable in accordance with claim 1, wherein said actuator action portion has a cross sectional shape in the insertion direction of the flat flexible cable such that the cross-sectional length in a long-axis direction is greater than a cross-sectional length in a short-axis direction, and the contact beam is pushed upward by rotation of the actuator action portion when the actuator is opened.

3. An electrical connector for a flat flexible cable in accordance with claim 1, wherein said top beam exerts said force on the actuator body portion in said other direction when the actuator is opened by butting against the actuator body portion, but is separated from the vicinity of the free end of the contact beam.

4. An electrical contact for a flat flexible cable in accordance with claim 1, wherein said top beam exerts said force on the actuator body portion in said other direction when the actuator is opened by butting against the actuator body portion, and also butting against the vicinity of the free end of the contact beam.

5. An electrical contact for a flat flexible cable in accordance with claim 1, wherein said actuator receives, from the plurality of contact pieces arranged at positions spaced in the direction perpendicular to the direction of insertion of the flat flexible cable, a force which is the difference between the force in the one direction from the contact beams and the force in the other direction from the top beams.
